(19) United States
(12) Patent Application Publication
(10) Pub. No.: US 2007/0006152 A1
(43) Pub. Date: Jan. 4, 2007

(54) Software source asset management

(75) Inventors: Shakil Ahmed, Woodinville, WA (US); Anthony Jones, Kirkland, WA (US); David Lawler Christiansen, Kirkland, WA (US); David Probert, Woodinville, WA (US); Naveen Sethuraman, Bellevue, WA (US); Lisa Grayson, Seattle, WA (US); Mark Wodrich, Issaquah, WA (US); Rajesh Munshi, Redmond, WA (US); Valerie Moore, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/171,636

(22) Filed: Jun. 29, 2005

(51) Int. Cl. G06F 9/44

(52) U.S. Cl. 717/122; 717/110; 717/106; 717/120; 717/123

(57) ABSTRACT

Code information is marked by tags and tags are embedded into pieces of code or files called “codetags” that map tags to pieces of code. These tags can then be updated, searched, sorted, recombined, and tracked, among many other feedback mechanisms. These tags and their feedback mechanisms help to illuminate the engineering metadata and business metadata of pieces of code so as to help engineering management and business management of companies to better guide their software resources.

### FIELD OF THE INVENTION

The invention relates to software including instructions that make hardware work.

### BACKGROUND

Source code is a set of human-readable program statements written by a developer in a high-level or assembly language that is not directly readable by a computer. Source code needs to be compiled into object code before it can be executed by a computer, and so in essence, the compilation process can be likened to a translation process from a language that man understands to another language that computers understand. Comments are a type of text often embedded in source code for documentation purposes. Comments usually describe what the program does, who wrote it, why it was changed, and so on. Most programming languages have a syntax for creating comments (i.e., “/*” in the C language, “//” in the C++ language, and “REM” in the Basic language) so that they can be recognized and ignored by the compiler or assembler.

Useful types of software, such as an operating system, are produced from numerous pieces of source code, various object code, which includes pre-compiled source code, and binary media containing such things as digital images. These numerous pieces of source code, object code, and binary media are typically organized into directories of files hierarchically forming a source tree. As developers make continuous changes to numerous files in the source tree, the maintenance of various files containing source code, object code, and binary media, can become arduously complex. To manage this complexity, many software manufacturers use version control systems to maintain all the source code and related files in software development projects so as to keep track of changes made during these development projects. The problem, however, is that valuable code information contained in the version control system or within the comments in the source files is often not correctly updated when a developer checks in a piece of source code to a version control system. In many important cases, the code information can become incorrect due to changes happening external to the source code. For example, if the developer who is responsible for the piece of code were to leave his employment or were to change his role within a company he works for, the version control system would not provide a way to reflect that the developer is no longer responsible for that piece of source code.

Another problem is the lack of an ability of present version control systems to classify whether a piece of source code is test code, sample code, product code, and so on; whether a piece of source code has a certain state, such as being vulnerable to security breaches, and so on; and whether the piece of code is governed by a license, and so on. Directories are used by developers as a catalog for filenames and other directories to form the source tree. Assumptions are made about whether a piece of source code is test code, product code, and so on, depending on the directories under which the piece of source code is organized. The problem arises when a piece of source code needs to be annotated by multiple pieces of code information (a certain classification with a certain state restricted by a certain license) or these pieces of code information are frequent changed over time requiring the creation of a large number of directories, each to annotate a particular permutation.

Software manufacturers do not always create their software from scratch. Some of them license pieces of software from other software manufacturers to quicken their software development processes. When a licensed piece of code is integrated together with other pieces of code that are created from scratch, over time, it may be difficult to determine whether the piece of code is a licensed piece of code or not so as to ascertain whether licensing obligations are being fulfilled. Version control systems lack the capability to track code information associated with licensed pieces of code. Developers often copy and paste pieces of code, thereby repurposing them from existing software products to new software products. The problem is that these re-use activities may be restricted by the terms of a license. Version control systems do not alert developers when re-use activities may involve licensed pieces of code.

Textual comments can be inserted and removed during development of human-readable source code to produce object code. Object code, which is code generated by a compiler or an assembler in the course of translating the source code of a program and binary media, cannot contain textual comments, hence no code information can be embedded. Although object code is unlike source code in that it is machine-comprehensible code that can be directly executed by the system's central processing unit, object code nevertheless has code information that is worthy of being tracked. For example, if a piece of object code was licensed, the management of a software manufacturer may want to know in which software products the licensed piece of object code is used. Version control systems presently cannot track object code in this manner.

### SUMMARY OF THE INVENTION

In accordance with this invention, a computer-readable medium, system, and method for tagging software is provided. The computer-readable medium form of the invention has a data structure stored thereon for expressing the characteristics of pieces of code, those who are responsible for pieces of code, and other metadata associated with pieces of code in a source tree. The data structure comprises structures for embedding tags in source code files and a file format for mapping metadata for files for which tags cannot be embedded, such as object files. These structures include a business tag that indicates business metadata for the piece of code and an engineering tag that indicates engineering metadata for a piece of code.

In accordance with further aspects of this invention, a system form of the invention includes a system for tagging software that comprises a source repository for maintaining source codes and related files; and a tagging database that communicates with the source repository to synchronize tag contents. The tagging database stores business tags that mark one or more agreements connected with pieces of code. The tagging database further stores engineering tags that mark engineering metadata of pieces of code.

In accordance with further aspects of this invention, a method form of the invention includes a method for tagging software. The method comprises tagging pieces of code with tags to mark their business and engineering metadata; and a notification process for instigating the update of metadata contained in the tags when internal or external inconsistencies are detected, such as changes to personnel identified by the tags.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary system for tagging software with metadata, and in particular an interface between a tagging database and a source repository and another interface between a developer workstation and the source repository;

FIG. 2 is a block diagram illustrating the exemplary system for tagging software with metadata, and particularly various feedback mechanisms coupled to the tagging database that allow the tagging database to track and update metadata;

FIG. 3 is a block diagram illustrating an exemplary system for tagging software, and particularly an interface between clients, such as an executive client, administrative client, and legal client, and with a tagging Web site and an interface (with tagging interfaces) between the tagging Web site and the tagging database;

FIG. 4A is a textual diagram illustrating an exemplary schema of a business tag;

FIG. 4B is a textual diagram illustrating an exemplary schema of an engineering tag;

FIG. 4C is a textual diagram illustrating an exemplary schema of a codetag file; and

FIGS. 5A-5G are process diagrams illustrating an exemplary method for tagging software.

### DETAILED DESCRIPTION

Unlike software engineering managers, software business managers typically do not have ready access to pieces of code and extract metadata to enable better execution or supervision of the direction and the business affairs associated with software products. Information of this nature may help both technical and business management determine the need to procure new resources or shift existing resources to carry out business objectives. Code information degrades over time. For example, developers often migrate from one team to another team within an organization, however, potentially affecting the responsibility for many pieces of code, and may even leave the organization altogether. The metadata that identifies the developer degrades after the developer leaves. Various embodiments of the present invention mark metadata in tags and tags are embedded directly into pieces of code or auxiliary files called “codetag” that map tags to pieces of code, such as those in directories described by a source tree. These tags can then be updated, searched, sorted, recombined, and tracked, among many other feedback mechanisms. These tags and their feedback mechanisms help to illuminate the engineering metadata and business metadata of pieces of code so as to help the engineering management and business management of companies to better guide their software resources.

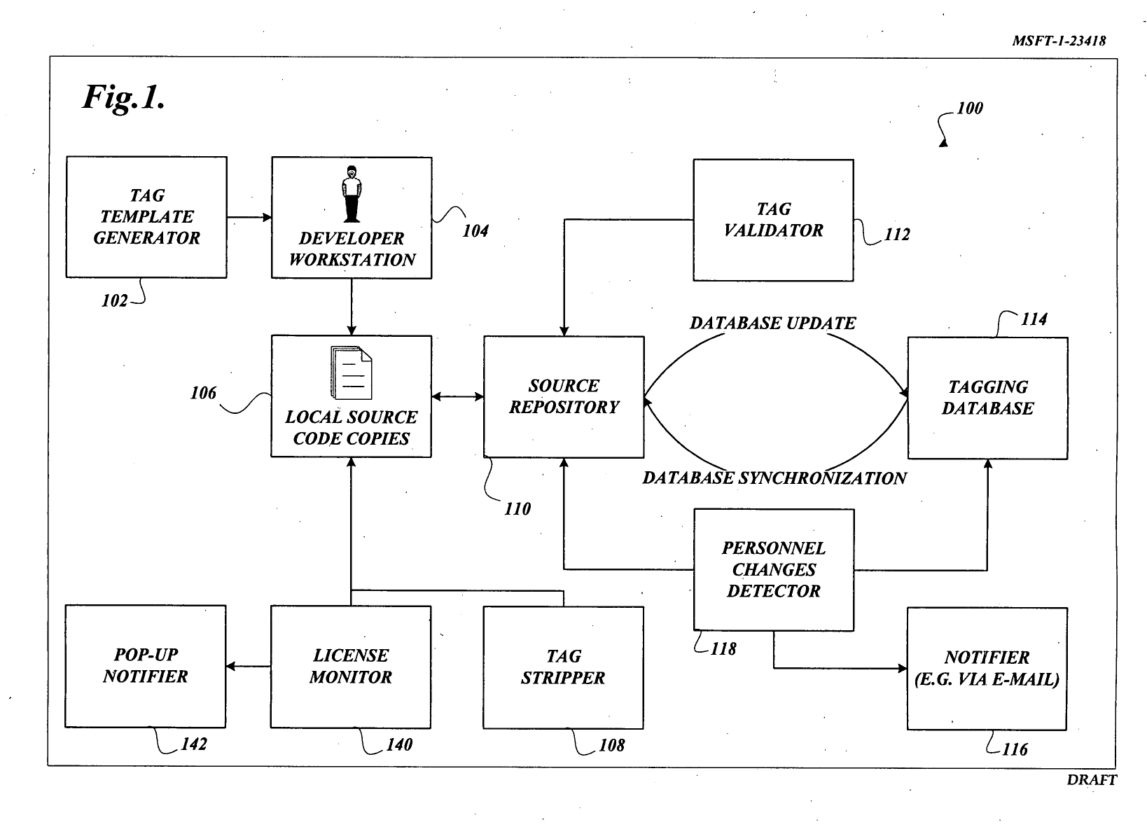

FIG. 1 illustrates an exemplary system 100 for tagging software. A developer workstation 104 is a networked computer of the sort used in software development and other applications requiring a computation machine with considerable engineering capabilities. A developer uses the developer workstation 104 to work on local source code copies 106, which are pieces of source code checked out from a source repository 110. As the developer accesses pieces of source code, a license monitor 140 detects such accesses. Any suitable license monitor can be used. One suitable license monitor includes modifying a source code editor (not shown) to check cut-and-paste operations against business tags. The developer may receive notification from a pop-up notifier 142 if he copies and pastes licensed pieces of code that may have predefined restrictions. Local source code copies 106 can be developed from scratch by the developer using the developer workstation 104. They can also be pieces of existing source code that are modified by the developer. Alternatively, they can also be pieces of source code that are copied and pasted from other source code files.

A tag template generator 102 aids the developer in creating proper tags to mark pieces of code with information to facilitate subsequent feedback processes. For code that is licensed, the tag template generator 102 represents a process for receiving the licensed code, inventorying, updating databases (e.g., a repository of intellectual property agreements 126), and tagging the code. The local source code copies 106 can be built together with other files into a software product. A tag stripper 108 can be used to strip tag information from software product to be distributed to customers so that sensitive information contained in the tag is removed. When the developer has finished making changes, he checks the local source code copies 106 into the source repository 110. The source repository 110 is a repository of all the source code and related files in a source tree for various software development projects that the developer is involved with and allows him to keep track of changes made to the source tree during the development of various projects. A tag validator 112 verifies and validates tags in the source repository 110 to determine whether they are malformed or conform to various tag schemata (discussed below).

Tags that are stored in the source repository 110 are preferably also stored in the tagging database 114. The tagging database is essentially a collection of records, each containing fields together with a set of database operations. The format of records in the tagging database 114 is formed from a number of fields and specifications regarding the type of data that can be entered in each field, as well as the field names used. There are preferably at least two types of tags: business and engineering. The business tags refer to an agreement governing the licensing of a piece of code. An engineering tag indicates information pertaining to responsibility assignment (ownership), the module of which the piece of code is a part, the class that categorizes the piece of code, and intellectual property identification indicating that intellectual property is implemented in the piece of code. The tagging database may have a number of tables. One table contains engineering tags and another table contains business tags. Preferably, a key identifier among the tables is the file in which pieces of code reside.

Tags in the source repository 110 can be synchronized with tags in the tagging database 114 via a database synchronization process. The database synchronization process is preferably executed infrequently, such as once a week, once a month, or on an as needed basis, to avoid constant updating the source repository 110 with metadata changes only. Another process, a database update process, takes updated information in the tags in the tagging database 114 and migrates the updated information to tags stored in the source repository 110. Preferably, the database update process can be executed more frequently, such as once a day, to ensure that tag information in the source repository 110 is refreshed and current. In some embodiments of the present invention, the database update may be integrated into source respository check-in procedures.

A personnel changes detector 118 communicates with both the tagging database 114 and the source repository 110 to review responsibility assignment of various pieces of code connected with tags to determine whether developers assigned to be responsible for these pieces of code are still current. If changes exist, the personnel changes detector 118 issues a notification via a notifier 116 by sending out suitble communications, such as e-mail to another person who can correct the information contained in the tags, the updated versions of which are stored in the source repository 110 and the tagging database 114. In certain cases, the personnel changes detector 118 may automatically update the tagging database 114, such as assigning responsibility to the manager of a developer who has left the company or has been reassigned.

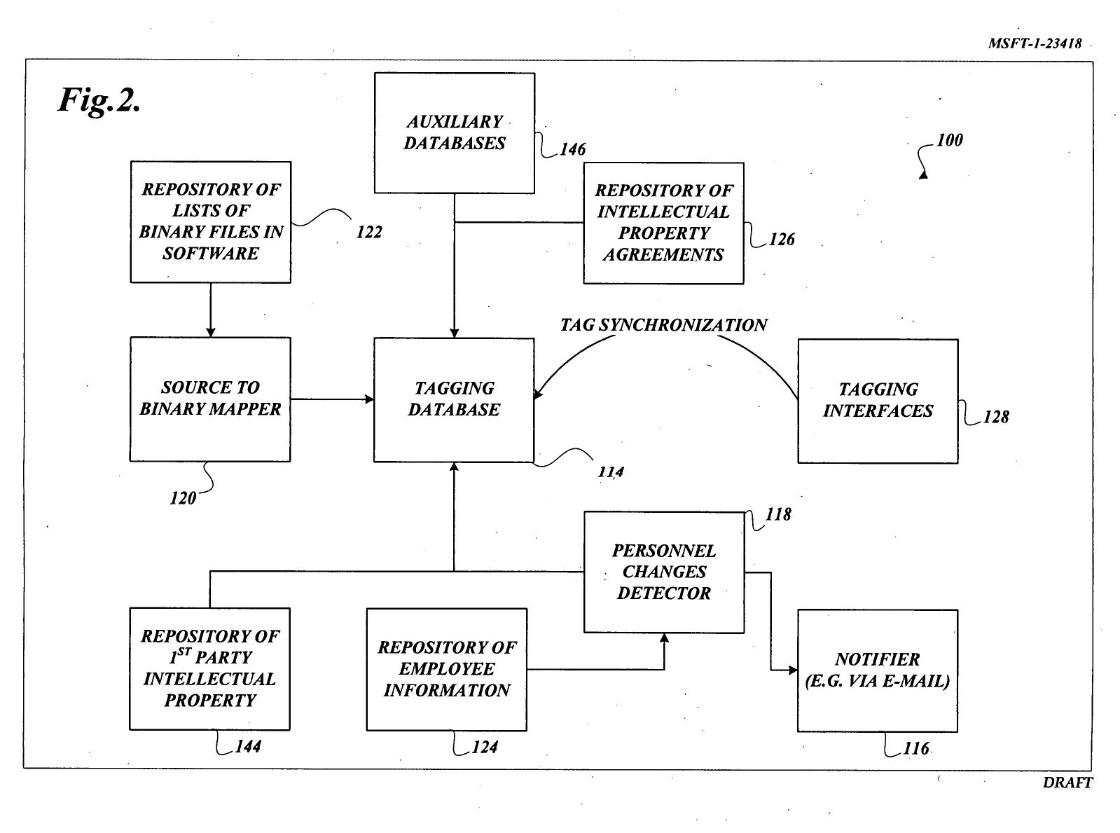

A source to binary mapper 120 is coupled to the tagging database 114. See FIG. 2. Software products are built using many pieces of object code which are stored in binary files. A repository 122 contains lists of binary files in software products shipped by a software manufacturer. The source to binary mapper 120 correlates object code in binary files with source code in source files marked by tags stored in the tagging database 114. This facilitates the ability to query the tagging database 114 to reveal pieces of source code that are used in actual software products, among other things. A repository 126 of intellectual property agreements is also coupled to the tagging database 114. Not all pieces of code used by a software manufacturer are developed by the software manufacturer from scratch, but are often licensed from other entities. Those licensed pieces of code are governed by agreements which can be found in the repository 126. Various tags used to tag pieces of code in various embodiments of the present invention can relate back to one or more specific agreements in the repository 126. This coupling facilitates verification that a piece of code can be modified by developers of the software manufacturer.

The pieces of code developed by a software manufacturer may represent concretizations of various pieces of intellectual property owned by the software manufacturer. A repository of 1st party intellectual property 144 associates pieces of intellectual property owned by the software manufacturer with metadata in various tags in various pieces of code. This permits a legal client 132 of the software manufacturer to query for various pieces of information, such as pieces of source code that are concretizations of a specific piece of intellectual property.

The personnel changes detector 118 and the notifier 116 have been previously discussed and for brevity purposes the description will not be repeated here. The personnel changes detector 118 communicates with a repository of employee information 124 so as to ascertain whether there have been changes in employment information that may affect information in the tagging database 114. The repository contains organization information that includes managers and developers who are managed by various managers. When an employee, such as a developer, leaves his employment, the organization information will reflect such changes and the manager of the developer can be notified by the notifier 116 to update responsibility information in various pieces of code maintained by the employee who has left. If there have been changes in the repository 124 connected with various tags in the tagging database 114, the personnel changes detector 118 initiates notification to a proper party to update the information in the tagging database 114 via a notifier 116.

Tagging interfaces 128 are preferably comprised of scripts that allow clients to access the tagging database 114 to make changes or update the information contained in various tags. Each script is preferably a program and is used by various embodiments of the present invention to customize or add interactivity to Web pages to facilitate access to tags stored in the tagging database 114. For example, a tagging interface may provide tools to allow an administrative client 136 to manage a reorganization of a development group to ensure that all source code files have corresponding properly assigned persons who are responsible for these source code files at the end of the reorganization. A tag synchronization process updates tags in the tagging database 114 with refreshed information collected by the tagging interfaces 128 from various clients (discussed below).

In addition to the tagging database 114 and various repositories 110, 122, 124, 126, 144, auxiliary databases 146 can be used in conjunction with metadata stored in various files in the source tree to manage source assets or support various business logic. For example, the auxiliary databases 146 may include a database which records files in the source tree that participated in the manufacturing of a particular software product. As another example, the auxiliary databases 146 may include a database that, together with the repository of employee information 124, can form a list of pieces of source code that are not needed. Many other suitable analyses are possible.

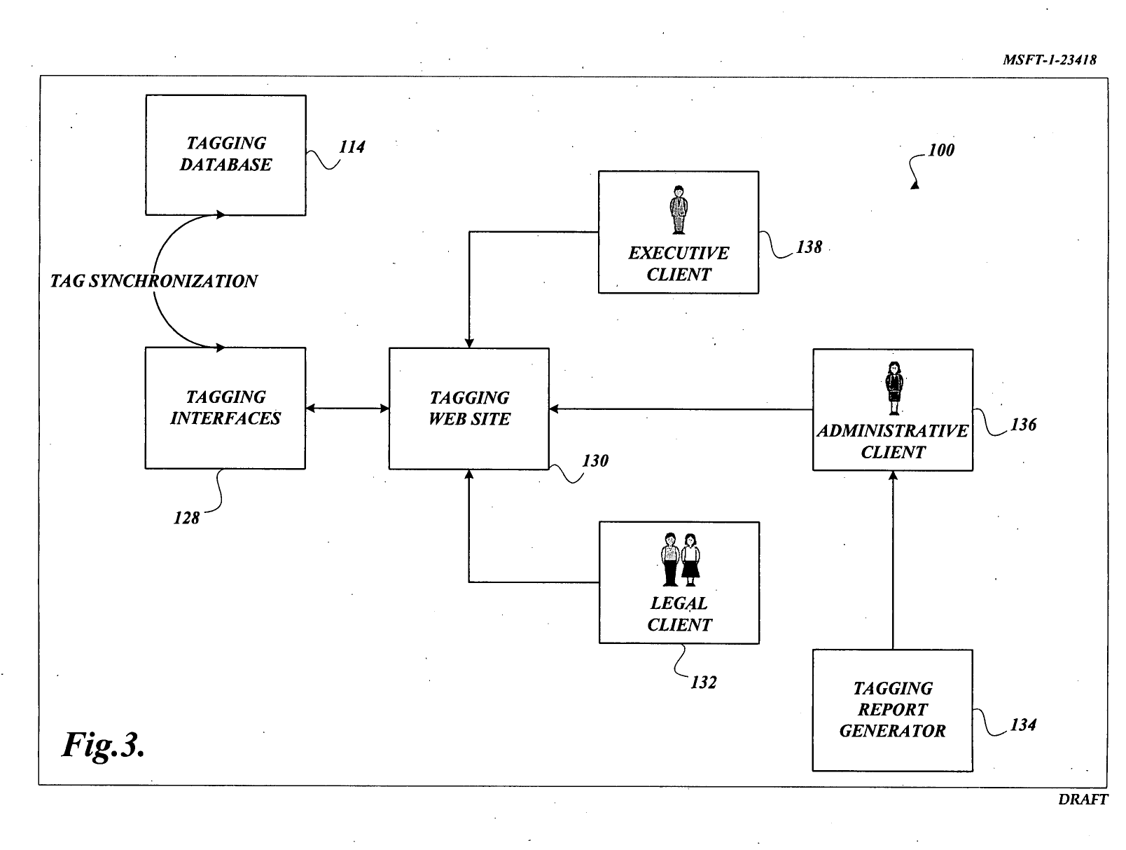

A tagging Web site 130 is coupled to the tagging interfaces 128. See FIG. 3. Clients, such as an executive client 138, an administrative client 136, and the legal client 132, can be connected to the tagging Web site 130 to make changes to tags stored in the tagging database 114. This architecture decouples the executive client 138, the administrative client 136, and the legal client 132 from the engineering details associated with tags stored in the source repository 110 including access to the source code since such access is often restricted and requires specialized skills. The tagging Web site 130 is a group of related Web documents and associated files and scripts that are served by a Web server on an intranet. The Web documents in the tagging Web site 130 generally cover one or more topics connected with tags and are interconnected through hyperlinks. Clients 138-132 access the tagging Web site 130 through these hyperlinked Web documents to make changes to tags stored in the tagging database 114 as well as to request reports to help guide decisions.

The executive client 138 has access to reports that provide information such as the amount of intellectual property that each manager within an organization manages; the number of lines of code managed by each manager; the effect on the management of various pieces of source code if a reorganization were to occur, and so on. The administrative client 136 preferably handles personnel who migrate to various groups within the software manufacturer or personnel who leave their employment. The administrative client 136 uses the tagging Web site 130 to update responsibility information pertaining to various pieces of code. The administrative client 136 has access to a tagging report generator 134 to request various reports. Typically, the administrative client is a manager of a developer who has or has had responsibility over various pieces of code. Another client is the legal client 132 which through the tagging Web site 130 can query tag information to determine various pieces of information, such as the amount of licensed code used in software products as well as software products that implement the intellectual property of a software manufacturer.

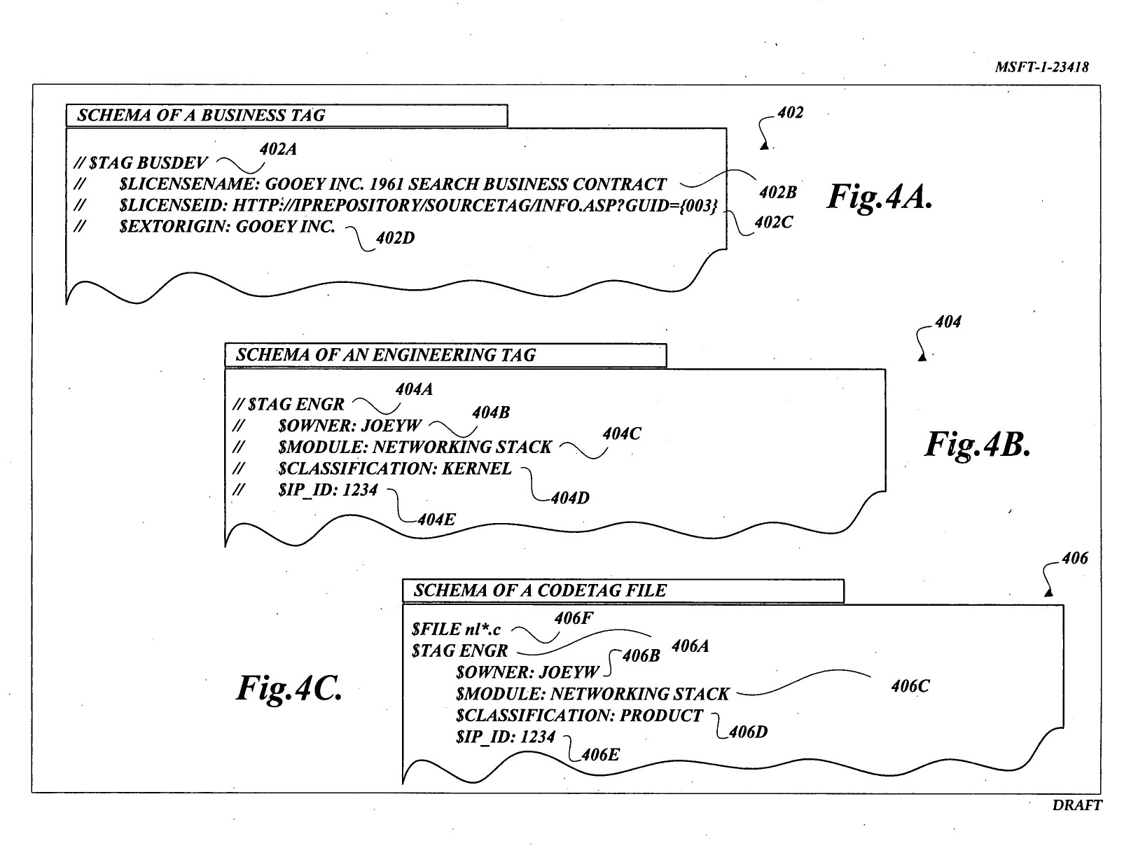

FIG. 4A illustrates a schema of a business tag 42. Preferably, the business tag 402 is used once per file. If the business tag 402 is placed into source code, preferably the business tag 402 is embedded in comments indicated by suitable symbols. Many suitable comment syntactical symbols can be used, such as “/* */” for the C language, “//” for the C++ language, and/or “REM” for the BASIC programming language. The business tag 402 is used to mark pieces of code licensed by an entity different from the entity using the pieces of code. Preferably, agreements are kept in a repository such as the repository 126. Business tags allow information to be present in code that can relate back to agreements that are stored in a repository so as to facilitate a relationship between pieces of code and agreements under which various pieces of code are licensed. Line 402a contains an expression “STAG BUSDEV”, which includes a key word “STAG” for signifying the beginning of a tag; and a tag name “BUSDEV” signifying that the information following is related to a business tag. Line 402b includes a field “$LICENSENAME” which indicates the name of an agreement. The value of the field “$LICENSENAME” as expressed on line 402b is “GOOEY INC. 1961 SEARCH BUSINESS CONTRACT” which specifies the name of the agreement. Line 402c includes a field “$LICENSEID” signifying an address, such as a Web address, at which the agreement may be found. The Web address “HTTP://IPREPOSITORY/SOURCETAG/INFO.ASP?GUID={003}” is the value for the field “$LICENSEID” at line 402c. Line 402d includes the field “$EXTORIGIN” signifying the external entity who is the licensor. The value in the field “$EXTORIGIN” is a company's name, which in this case is “GOOEY INC.”

FIG. 4B illustrates a schema of an engineering tag 404. Line 404a includes a keyword “STAG” for defining the beginning of a tag block. Line 404a also includes a tag name “ENGR” signifying that the tag block is connected with an engineering tag. Lines 404b-404e define fields that are connected to the engineering tag 404. Line 404b includes the field “$OWNER”, which signifies a person who has primary responsibility for maintaining the piece of code. This person may not necessarily have written the piece of code. Line 404b identifies that the responsible party has an alias “JOEYW” and preferably the alias is an e-mail alias. The field “$OWNER” can indicate a developer who is responsible for the maintenance of the tagged piece of code and in the instance where the piece of code is no longer actively maintained, the field indicates a person who is responsible for removing it from a source tree. If the piece of code is a test code, the responsible person can be a test engineer. On the other hand, if the piece of code is binary, the responsible person may be a program manager. Line 404c contains the field “$MODULE” signifying a module to which the piece of code belongs. Line 404c indicates the value to the field “$MODULE” is a module name “NETWORKING STACK”. The name of the module expressed by line 404c is used to provide organization of software in a source tree. In other words, the piece of code marked by the engineering tag 404 is a part of a networking stack software. Line 404d contains the field “$CLASSIFICATION” indicating a categorization for the piece of code marked by the engineering tag 404. The value “PRODUCT” on line 404d indicates that the piece of code marked by the engineering tag 404 is classified as code that is used in a software product. Line 404e includes a field “$IP_ID” indicating one or more intellectual property identifiers for associating the piece of code as implementing one or more aspects of various pieces of intellectual property owned by an organization. See FIG. 2. A numerical value “1234” acts as an identifier for the field “$IP_ID”. Other optional fields include rule, which provides guidance on the boundaries within which to use the tagged piece of code, and contributor, which defines a list of contributors to the tagged piece of code. Preferably, multiple instances of the engineering tag 404 may be embedded in a source file. The first tag provides metadata for pieces of source code up to a second tag, and so on. This allows different parts of a source file to be characterized differently. For example, a source file may be tagged having both test code and product code depending on where the test code ends and the product code begins.

The metadata fields for business tags and engineering tags are preferably defined so that the database synchronization (FIG. 1) is able to resolve conflicts between field values in the source repository 110 and the tagging database 114. Preferably, each field is independently determined whether the source repository 110 or the tagging database 114 is the authority for a correct field value. Preferably, the source repository 110 has precedent for all fields in a new code file until such time that the tagging database 114 has created a record for the new code file.

For files that are not modifiable, such as binary files containing object code and files containing licensed pieces of code, preferably a file named “CODETAGS” is added to the directory containing the non-modifiable files in that directory. There can be an overlap between tags contained in a file and tags contained in a codetag file. In this instance, the tags in the file have precedence over the tags contained in the codetag file. The file “CODETAGS” contains tags that include both business tags and engineering tags organized by an exemplary schema 406. See FIG. 4C. Line 406f includes a key word “$FILE” indicating the files that will be tagged by the information on lines 406a-406e. The value for the keyword “$FILE” at line 406f is “NL*.C” indicating that for all files beginning with the letter combination “NL” and ending with the suffix “.C”, these files will be marked by the tagged information on lines 406a-406e. Lines 406a-406e are identical to lines 404a-404e and for brevity purposes their description will not be repeated here.

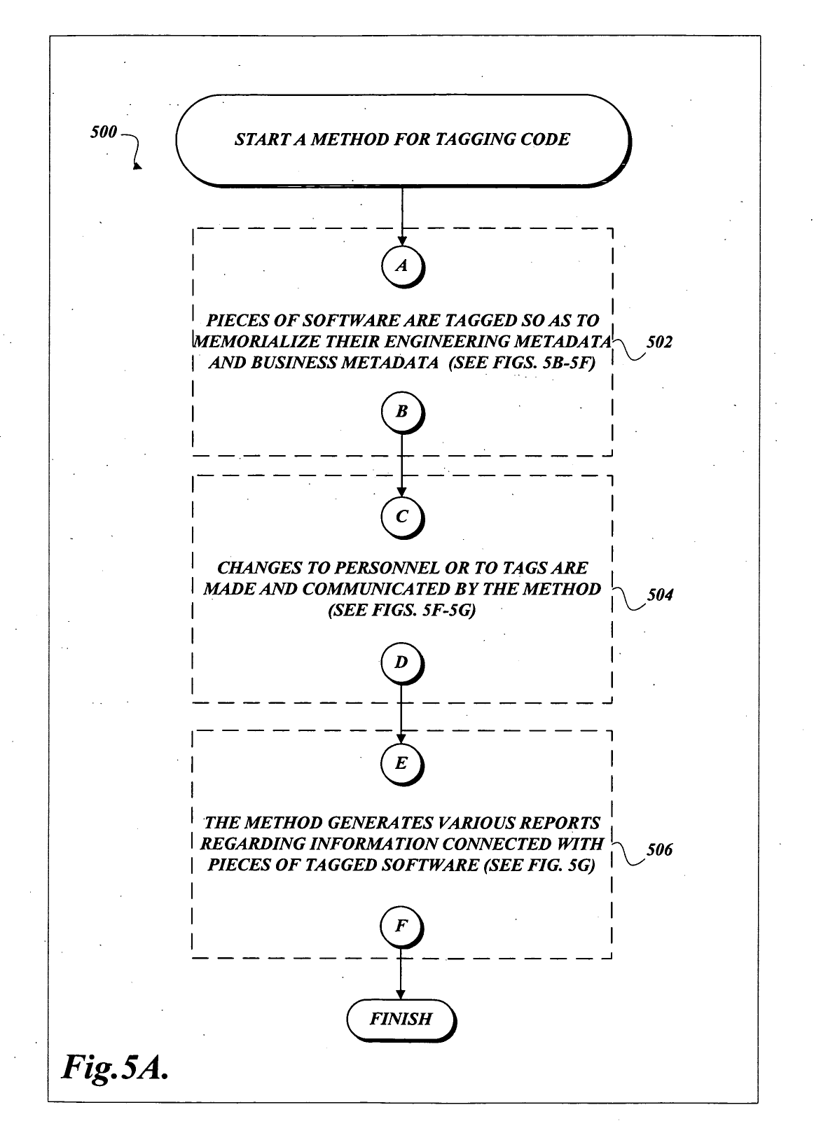

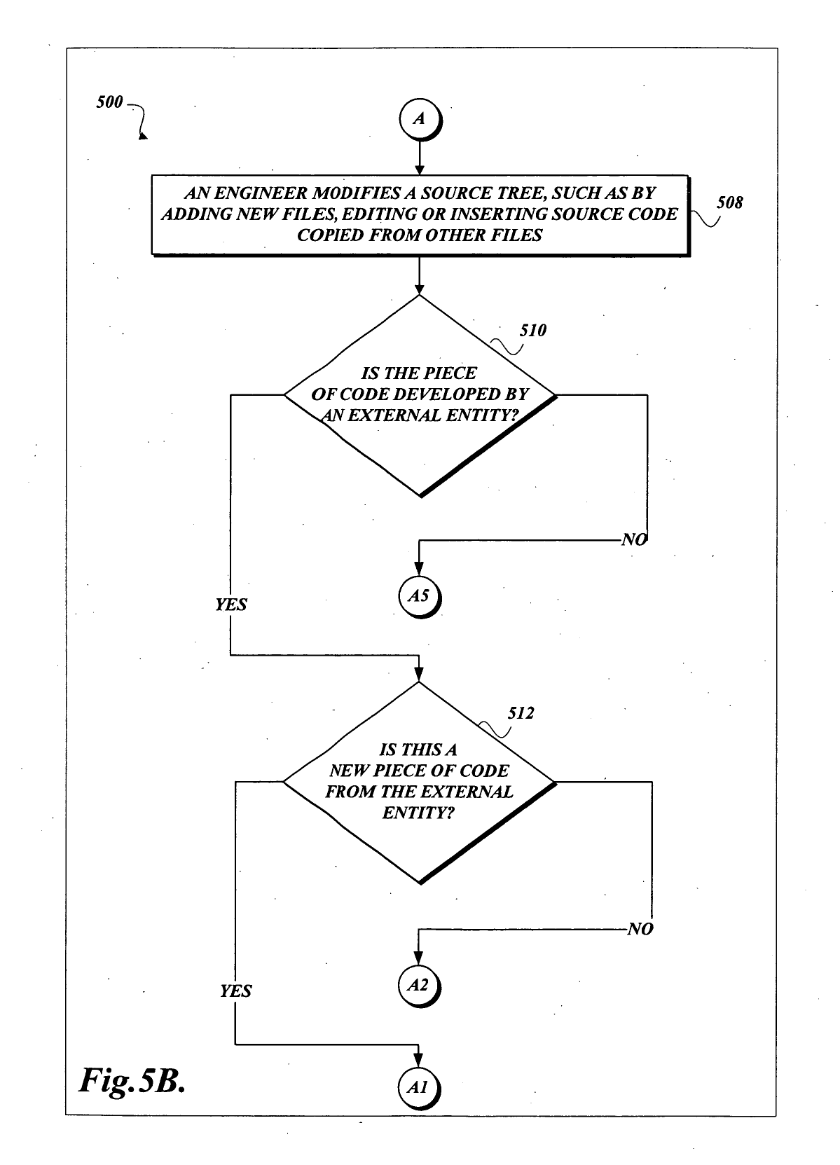

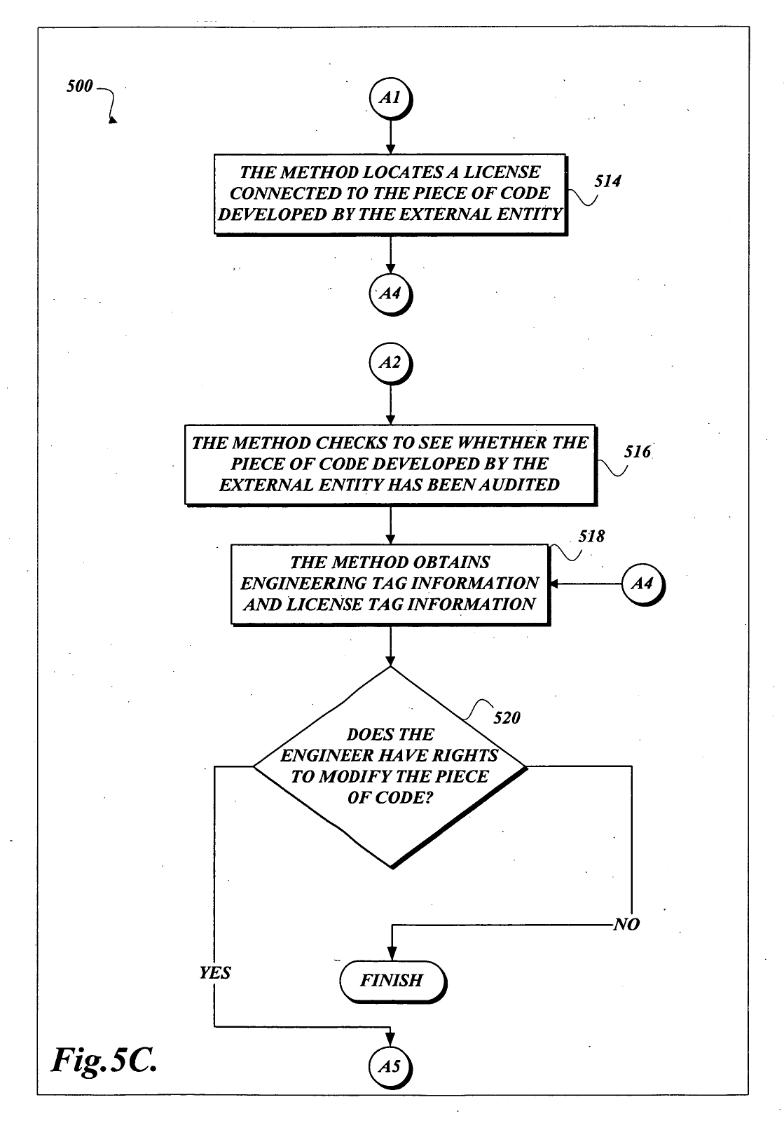

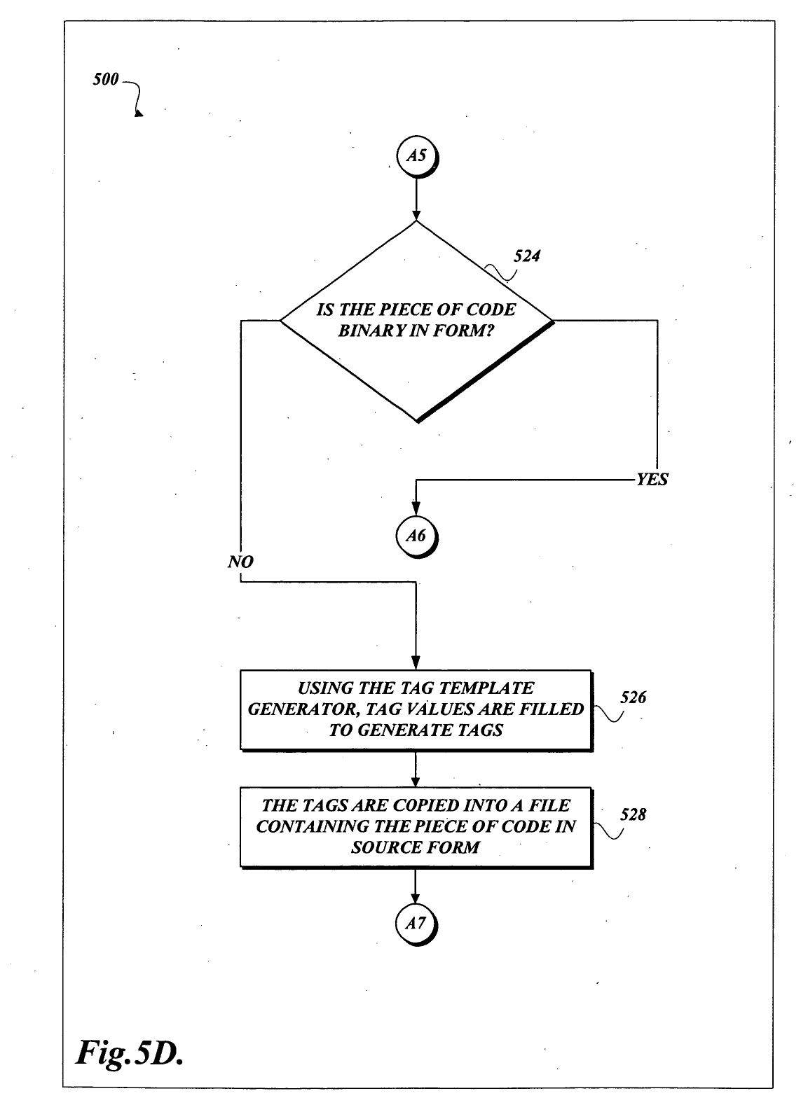

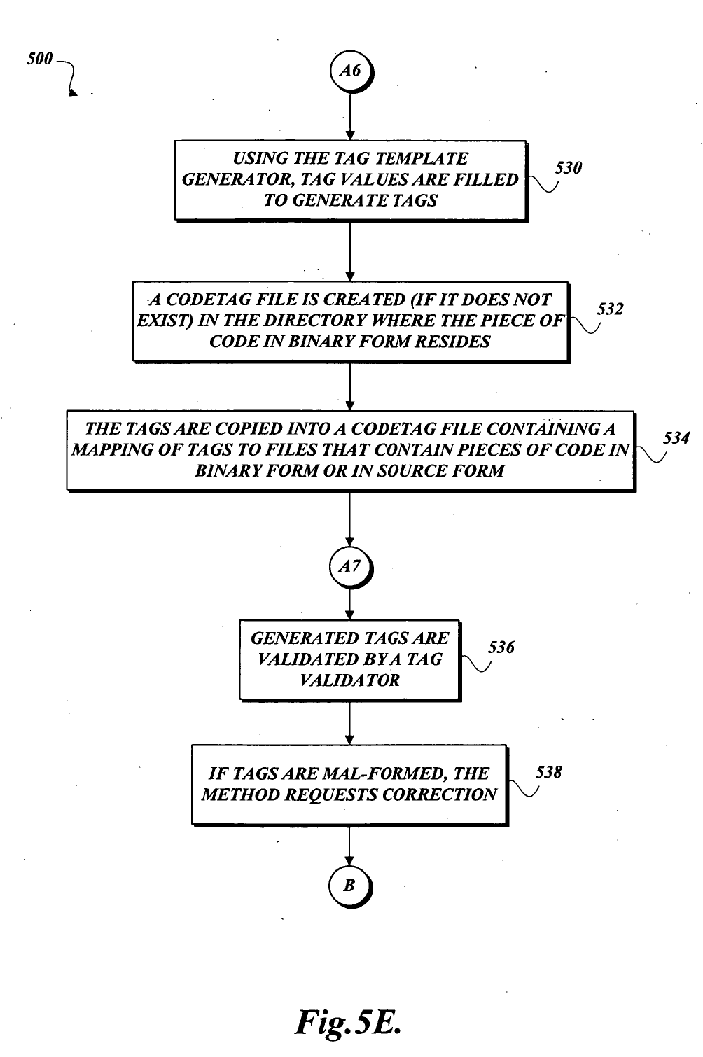

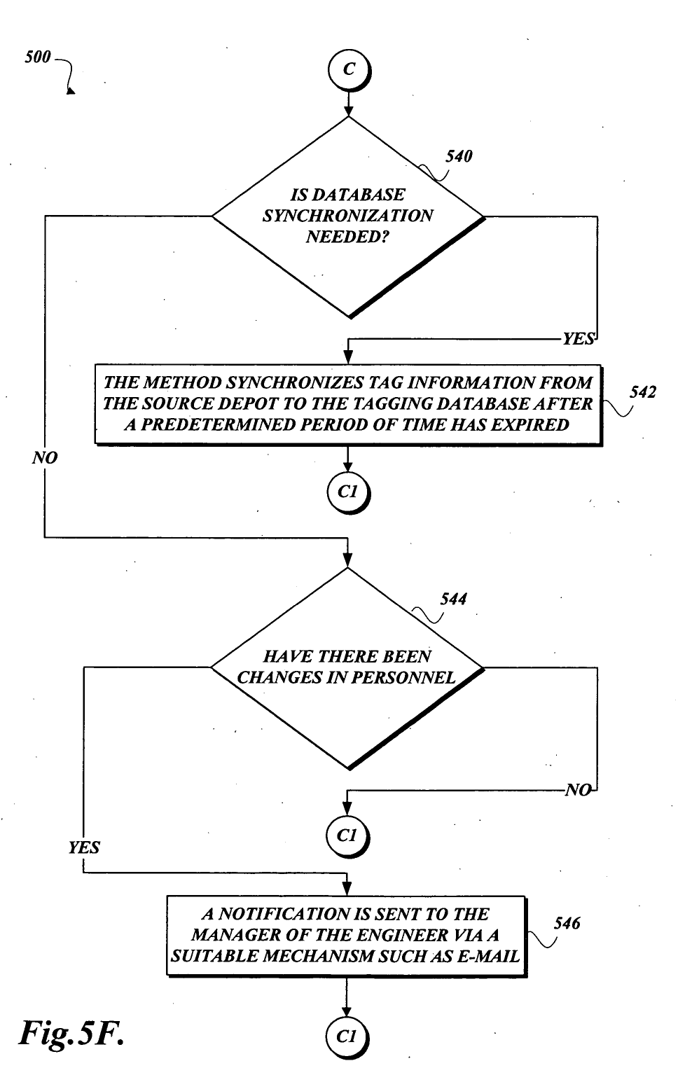

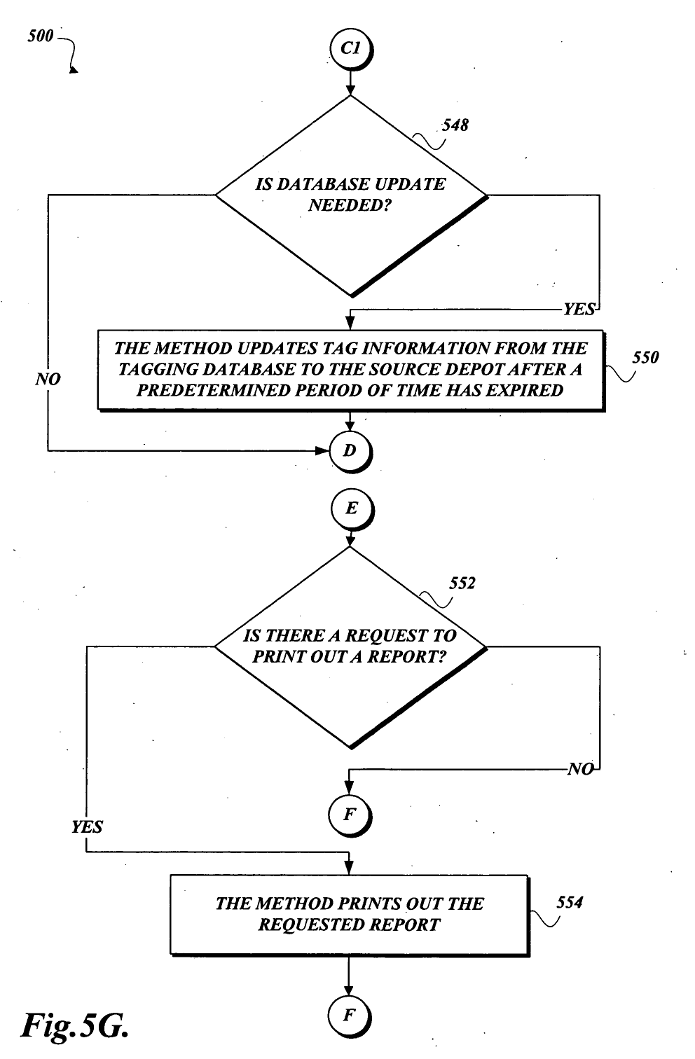

FIGS. 5A-5G illustrate a method 500 for tagging software. From a start block, the method 500 proceeds to a set of method steps 502 defined between a continuation terminal (Terminal A) and another continuation terminal (Terminal B), for defining a process in which pieces of software are tagged so as to memorialize their engineering metadata and business metadata.

From terminal A (FIG. 5B) the method 500 proceeds to block 508 where an engineer modifies code in a source tree by means such as by adding new files, editing, or inserting source code copied from other files. A test is performed at decision block 510 to determine whether the piece of code was developed by an external entity that has provided a license. If the answer to the test at decision block 510 is NO, the method 500 proceeds to another continuation terminal (“Terminal A5”). If, on the other hand, the answer to the test at decision block 510 is YES, another test is performed at decision block 512 to determine whether the piece of code is a new piece of code from the external entity. In other words, the test performed at block 512 determines whether the piece of code is an existing piece of code or a new piece of code. If the answer to the test at decision block 512 is NO, the method 500 proceeds to another continuation terminal (“Terminal A2”). If, on the other hand, the answer to the test at decision block 512 is YES, the method 500 proceeds to another continuation terminal (“Terminal A1”).

From Terminal A1 (FIG. 5C), the method 500 proceeds to block 514 where the method locates a license connected to the piece of code developed by the external entity, such as by accessing the repository 126 containing the intellectual property agreements. The method 500 then continues to another continuation terminal (“Terminal A4”) and skips to block 518 (discussed below).

From Terminal A2 (FIG. 5C), the method 500 proceeds to block 516 where the method checks to see whether the piece of code developed by the external entity has been audited to establish that the correct licensing information has been associated with the file, and proceeds to correct the licensing information if it is incorrect. The method 500 then proceeds to block 518 and obtains engineering tag information and business tag information. The method 500 then continues to decision block 520 where a test is performed to determine whether the engineer has rights to modify the piece of code according to the license. For example, the engineer may be attempting to copy a licensed piece of code that is restricted from copying. If the answer to the test at decision block 520 is NO, the method terminates execution. If, on the other hand, the answer to the test at decision block 520 is YES, the method 500 proceeds to another continuation terminal (“Terminal A5”).

From Terminal A5 (FIG. 5D), the method 500 proceeds to decision block 524 where a test is performed to determine whether the piece of code is binary in form. If the answer to the test at decision block 524 is YES, the method 500 continues to another continuation terminal (“Terminal A6”). If, on the other hand, the answer to the test at decision block 524 is NO, the method 500 continues to block 526 where, using the tag template generator, tag values are filled in a form to generate tags. At block 528, the tags are copied into a file containing the piece of code in source form. The method 500 then continues to another continuation terminal (“Terminal A7”).

From Terminal A6 (FIG. 5E), using the tag template generator, tag values are filled in a form to generate tags. See block 530. At block 532, a codetag file is generated (if it does not exist already) in the directory where the piece of code in binary form resides. The method 500 then proceeds to block 534 where the tags are copied into a codetag file containing a mapping of tags to files that contain pieces of code in binary form or in source form. See the schema of a codetag file 406. The method 500 then continues to Terminal A7 and continues further to block 536 where generated tags are validated by a tag validator. At block 538, if tags are malformed, the method requests correction. The method 500 then continues to Terminal B.

From Terminal B (FIG. 5A), the method continues to a set of method steps 504 defined between a continuation terminal (“Terminal C”) and another continuation terminal (“Terminal D”) for defining processing steps where changes to personnel or to tags are made and communicated by the method 500. From Terminal C (FIG. 5F), the method 500 proceeds to decision block 540 where a test is performed to determine whether database synchronization is needed. If the answer to the test at decision block 540 is YES, the method synchronizes tag information from the source repository to the tagging database after a predetermined period of time has expired. See block 542. If a tag exists in the source repository but not in the tagging database, the tagging database will be populated with the new tag. When the new tag has been created in the tagging database, the tagging database will be the source from which further updates occur. The method 500 then continues to another continuation terminal (“Terminal C1”). If the answer to the test at decision block 540 is NO, the method continues to decision block 544 where another test is performed to determine whether there have been changes to various databases and repositories, such as changes in the repository of employee information 124. If the answer to the test at decision block 544 is NO, the method 500 continues to Terminal C1. If the answer to the test at decision block 544 is YES, a default rule can be executed to correct responsibility assignment, and a notification is sent to the manager of the engineer via a suitable mechanism such as e-mail or instant messaging. See block 546. The method 500 then continues to Terminal C1.

From Terminal C1 (FIG. 5G), the method 500 proceeds to decision block 548 where a test is performed to determine whether the database needs to be updated. If the answer to the test at decision block 548 is YES, the method updates tag information from the tagging database to the source repository after a predetermined period of time has expired. See block 550. The method then continues to Terminal D. If the answer is YES to the test at decision block 548, the method also continues to Terminal D.

From Terminal D (FIG. 5A), the method continues to a set of method steps 506 defined between a continuation terminal (“Terminal E”) and another continuation terminal (“Terminal F”). The set of method steps 546 defines processing steps where the method generates various reports regarding information connected with pieces of tagged software. From Terminal E (FIG. 5G), the method 500 proceeds to decision block 552 where a test is performed to determine whether there is a request to print out a report. If the answer to the test at decision block 552 is NO, the method 500 proceeds to Terminal F and terminates execution. If the answer to the test at decision block 552 is YES, the method 500 prints out the requested report and continues to Terminal F and terminates execution. Exemplary reports that are accessible by an administrative client 136 include a report that indicates which team within an organization is responsible for various modules and another report that indicates the lines of code that a developer is responsible for. Another exemplary report that is accessible by the executive client 138 is whether a team uses a large number of pieces of licensed code and therefore does not require resources to maintain these pieces of licensed code. A further exemplary report includes a report that indicates pieces of source code participating in a release of a software product. An additional exemplary report includes a report that specifies the lines of code that a team is responsible for.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer-readable medium having a data structure stored thereon for expressing metadata of a piece of code, the data structure comprising:
a file tag that indicates a file in which a piece of code is being tagged;
a business tag that indicates business metadata for the piece of code; and
an engineering tag that indicates engineering metadata for the piece of code.

2. The computer-readable medium of claim 1, wherein the file tag can indicate one or more files.

3. The computer-readable medium of claim 1, wherein the business tag includes a field for storing a name of an agreement governing the use of the piece of code.

4. The computer-readable medium of claim 1, wherein the business tag includes a field for storing a Web address at which an agreement governing the use of the piece of code can be found.

5. The computer-readable medium of claim 1, wherein the business tag includes a field for storing a name of an entity who is a licensor to an agreement governing the use of the piece of code.

6. The computer-readable medium of claim 1, wherein the engineering tag includes an owner field that identifies a person responsible for the piece of code, the engineering tag further including a module field that identifies a software module that the piece of code is a part of.

7. The computer-readable medium of claim 1, wherein the engineering tag includes a classification tag that identifies a category to which the piece of code belongs, the engineering tag further including an intellectual property identifier for associating the piece of code with a piece of intellectual property.

8. A system for tagging software, comprising:
a source repository for maintaining source codes and related files; and
a tagging database that communicates with the source repository to synchronize tag contents, the tagging database storing business tags that mark one or more agreements connected with pieces of code, the tagging database further storing engineering tags that mark engineering metadata of pieces of code.

9. The system of claim 8, wherein the engineering tags include fields that express responsibilty assignment of a piece of code, a module of which the piece of code is a part, a class that categorizes the piece of code, and intellectual property identification indicating that a piece of intellectual property is implemented in the piece of code

10. The system of claim 9, further comprising a notifier that communicates via e-mail to a manager to change responsibility assignment of the piece of code when a developer who is responsible for a piece of code has left his employment.

11. The system of claim 10, wherein the notifier alerts a developer when the developer cuts and pastes pieces of code that are restricted by an agreement.

12. The system of claim 8, further comprising a tagging Web site which various clients can access to refresh information contained in tags.

13. The system of claim 8, further comprising a tagging report generator by which various clients can request reports obtained from tags.

14. The system of claim 8, further comprising a tag validator that indicates whether tags are malformed.

15. A method for tagging software, comprising:
tagging pieces of code with tags to mark their business and engineering metadata; and
notifying a person to update information contained in the tags when there are changes to personnel identified by the tags.

16. The method of claim 15, further comprising determining whether pieces of code are licensed pieces of code and whether an engineer has rights to modify the licensed pieces of code.

17. The method of claim 15, further comprising creating a codetag file for containing tags if the pieces of code are binary in form.

18. The method of claim 15, further comprising querying a tagging database containing tagged pieces of code for information related to pieces of code that participate in a software product release.

19. The method of claim 15, further comprising synchronizing tags in a tagging database and tags in a source repository.

20. The method of claim 15, further comprising printing a report that indicates a number of modules for which a manager is responsible.
